(19) United States
(12) Patent Application Publication
(10) Pub. No.: US 2006/0071470 A1
(43) Pub. Date: Apr. 6, 2006

(54) Hose nipple and hose connecting means

(76) Inventors: Hans-Peter Meyer, Hemer (DE); Branislav Dragoljevic, Iserlohn (DE)

Correspondence Address: HOFFMAN WASSON & GITLER, P.C;CRYSTAL CENTER 2, SUITE 522, 2461 SOUTH CLARK STREET, ARLINGTON, VA, 22202-3843, US

(21) Appl. No.: 11/238,150

(22) Filed: Sep. 29, 2005

(30) Foreign Application Priority Data
Oct. 1, 2004 (DE) 20 2004 015 244.4

(51) Int. Cl. F16L 33/00

(52) U.S. Cl. 285/256

(57) ABSTRACT

A hose nipple for a hose connecting means for insertion in one end of a hose, having a first region of the hose nipple, which region is insertable into the hose and has a contacting surface which is then in bearing contact with the hose, the contacting surface having a knurl.

### BACKGROUND OF THE INVENTION

The invention relates to a hose nipple for a hose connecting means for insertion in one end of a hose, comprising a first region of the hose nipple, which region is insertable into the hose and has a contacting surface which is then in bearing contact with the hose. The invention further relates to a hose connecting means comprising a hose nipple of this type.

The hose nipple represented in FIGS. 1 and 1a has a so-called Christmas tree structure. The Christmas tree structure is formed by raising of the rings 2 on the outer side of the hose nipple 1 and stop bevels 3 adjoining the raised rings 2 in the direction of the end of the hose nipple 1. The stop bevels 3 allow the hose nipple to be pushed more easily into a hose end. In the case of an existing connection between the hose nipple 1 and the hose, the raised rings 2 make it more difficult for the hose nipple 1 to be pulled out of the hose. As a result of these Christmas tree structures, the connection between hose and hose nipple 1 has a higher tensile strength than a hose nipple having a smooth outer surface without Christmas tree structures.

The connecting forces between the hose nipple 1 and the hose are provided essentially in the region of the raised rings 2. At these points, the hose bears with a high force against the hose nipple 1. In the region between the rings 2, on the other hand, forces act between the hose nipple 1 and the hose, which forces make only a minor contribution to the retaining forces acting against the pull-out force. In the event of an unfavorable constellation, it can even come about that the hose, in the region between the rings 2, is not or is only partially in bearing contact against the hose nipple 1. In this case, the connecting forces between the hose nipple 1 and the hose act solely between the rings 2 and the hose.

Hose nipples having the Christmas tree structure represented in FIG. 1 and la have proved in the past to be of practical value. There has long been a need, however, for an improvement in the tensile strength of the connection between a hose and a hose nipple. This is where the present invention comes in.

An object of the invention is to improve the tensile strength of the connection between a hose nipple of the type stated in the introduction and a hose.

### SUMMARY OF THE INVENTION

This object is achieved according to the invention by the fact that the contacting surface of the first region of the hose nipple has a knurl. As a result of the knurl in the first region of the hose nipple, the static friction between the hose nipple and a hose is increased. This increase in static friction makes it possible for connections to be made between a hose nipple according to the invention and a hose with higher tensile strength than is the case with the hose nipples known from the prior art.

The knurl of a hose nipple according to the invention can be a left-right knurl or a cross-knurl. The knurl is preferably realized according to DIN 82 (RGE or RKE). The crests of the knurl are preferably heightened.

A hose nipple according to the invention can have in a second region a bead. The bead can have an external diameter which is 5 to 15% larger than the external diameter of the hose nipple in the first region. The second region, in which the bead is provided, adjoins the first region preferably toward the end of the hose nipple. The bead, too, can have a knurl. This knurl can in this case be realized just the same as the knurl of the contacting surface in the first region.

The transition from the first region to the second region is preferably of ramp-like configuration. The second region can have a stop bevel toward the end of the hose nipple.

A hose nipple according to the invention can be made of a metal or a metal alloy or of a plastic.

A hose connecting means according to the invention, in which an inventive hose nipple of the aforesaid type is inserted, can comprise in addition to the hose nipple a hose sleeve. This hose sleeve preferably embraces the first region of the hose nipple. The hose sleeve can at least in some portions have an internal diameter which is greater than the external diameter of the bead by less than the wall thickness of the hose.

### BRIEF DESCRIPTION OF THE DRAWINGS

An illustrative embodiment of a hose nipple according to the invention and of a hose connecting means according to the invention is represented in greater detail in the drawings, in which:

FIG. 1 and FIG. 1a respectively show a view of a hose nipple known from the prior art;

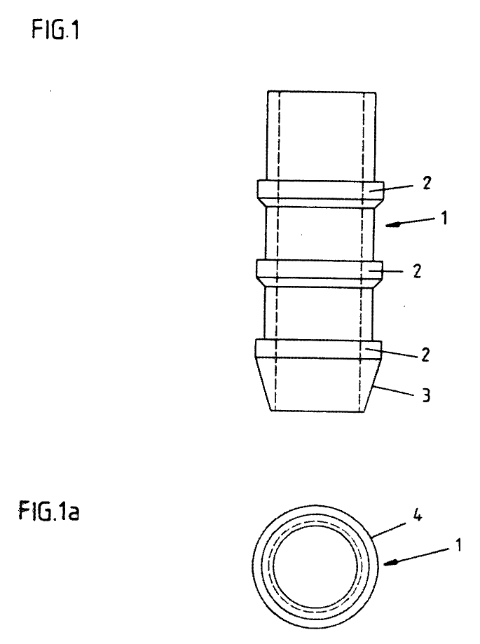

FIG. 2 and 2a show views of the hose nipple; and

FIG. 3 shows a sectional representation of the hose connecting means.

### DETAILED DESCRIPTION OF THE INVENTION

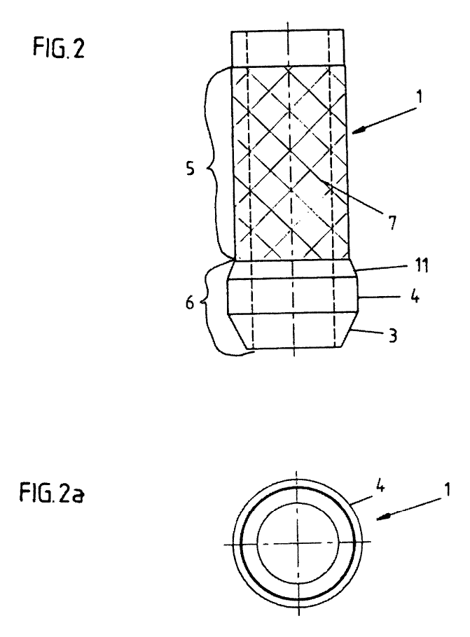

The hose nipple 1 represented in FIG. 2 and 2a gin side view and front view respectively has a first region 5 and a second region 6.

The second region 6 of the hose nipple 1 directly adjoins the end of the hose nipple. In this second region, the hose nipple has a bead 4. This bead 4 adjoins, toward the end, a stop bevel 3. The transition 11 from the second region 6 to the first region 5 is of ramp-like configuration.

In the first region 5 of the hose nipple 1, a contacting surface having a knurl 7 is provided. The knurl is here constituted by a cross-knurl according to DIN 82 (RKE) with exaggerated crests.

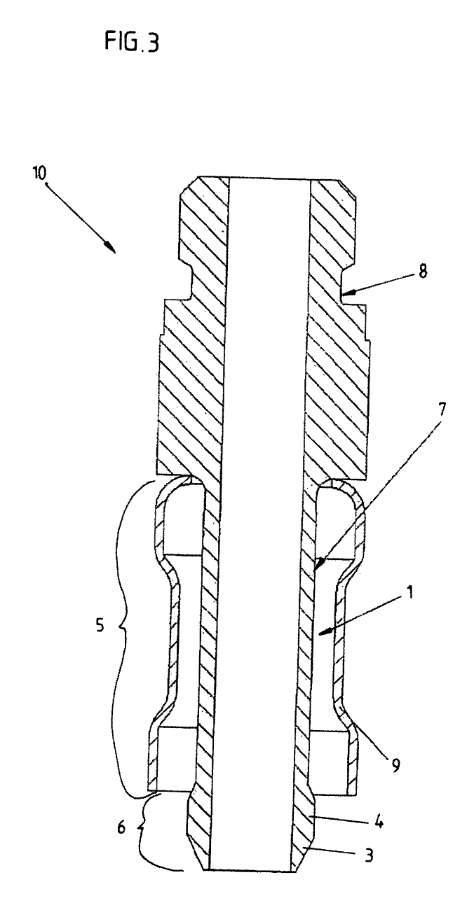

A hose nipple 1 as is represented in FIG. 2 and 2a is used in the inventive hose connecting means 10 according to FIG. 3. The hose nipple 1 is here adjoined by a nipple head 8. This nipple head has various connecting structures by which the hose connecting means can be connectable, for example, to a hose coupling.

In addition to the hose nipple 1 and the nipple head 8 fixedly connected thereto, the hose connecting means 10 has a hose sleeve 9. This hose sleeve, which is configured as a press sleeve, is disposed concentrically to the hose nipple so as to embrace it in its first region 5. The hose sleeve has a middle portion of a reduced diameter. In this region, the hose sleeve 9 is pinched so as to fix a hose (not represented) on the hose nipple 1 and, in particular, the first region 5 thereof.

As a result of the hose sleeve 9 and, in particular, the middle region of the hose sleeve 9, the hose is fixed on the knurl 7 in the first region 5 of the hose nipple. In order to remove the hose from the hose connecting means, retaining forces must be surmounted, which, owing to the bead 4 and the knurl 7, act in a strengthened manner between the hose and the hose nipple 1 in comparison to a hose nipple known from the art.

What is claimed is:

1. A hose nipple for a hose connecting means for insertion in one end of a hose, comprising a first region of the hose nipple, which region is insertable into the hose and has a contacting surface which is then in bearing contact with the hose, wherein the contacting surface has a knurl.

2. The hose nipple as claimed in claim 1, wherein the knurl is a left-right knurl.

3. The hose nipple as claimed in claim 1, wherein the knurl is a cross-knurl.

4. The hose nipple as claimed in claim 1, wherein the crests of the knurl are heightened.

5. The hose nipple as claimed in claim 1, wherein the hose nipple has in a second region a bead.

6. The hose nipple as claimed in claim 5, wherein the second region having the bead adjoins the first region at one end of the hose nipple.

7. The hose nipple as claimed in claim 5, wherein the bead has a knurl.

8. The hose nipple as claimed in claim 7, wherein the knurl of the bead corresponds to the knurl of the contacting surface.

9. The hose nipple as claimed in claim 5, wherein transition from the first region to the second region is of ramp-like configuration.

10. The hose nipple as claimed in claim 5, wherein the second region has a stop bevel toward the end of the hose nipple.

11. The hose nipple as claimed in claim 1, wherein the hose nipple consists of metal.

12. The hose nipple as claimed in claim 1, wherein the hose nipple consists of plastic.

13. A hose connecting means comprising a hose nipple and a hose sleeve, the hose nipple being insertable into one end of a hose and the hose sleeve enclosing the end of the hose, wherein the hose nipple is configured as claimed in claim 1.

14. The hose connecting means as claimed in claim 13, wherein the hose sleeve reaches over only the first region of the hose nipple.

15. The hose connecting means as claimed in claim 14, wherein the hose sleeve has an internal diameter which is greater than the external diameter of the bead by less than the wall thickness of the hose.
